(19) United States
(12) Patent Application Publication
(10) Pub. No.: US 2006/0091076 A1
(43) Pub. Date: May 4, 2006

(54) Solar powered rescue and/or utility device for producing portable water from salt water, brine water or impure water

(76) Inventor: Michael Thomas Marcellus, Aurora, IL (US)

Correspondence Address: MICHAEL T. MARCELLUS, 2610 Ryder Ct., League City, TX, 77573, US

(21) Appl. No.: 10/978,960

(22) Filed: Nov. 1, 2004

(51) Int. Cl. C02F 1/44

(52) U.S. Cl. 210/640; 210/747; 210/242.1

(57) ABSTRACT

A solar powered rescue and/or utility device for producing potable water from salt water, brine water or impure water which has an inflatable perimeter chamber to give device structural stability, an upper and lower skin that covers top and bottom of the device and a mid-level skin which creates two chambers between upper and lower skins. The mid-level skin has 8-10 slotted holes around the top circumference that are covered and sealed with a vapor porous hydrophobic membrane. The top skin has a movable flap that covers a hole which incorporates a screen. The flap retainer cuff is used to retain flap by keeping it flat. The hole, with the incorporated screen, is to allow water to be poured into the upper chamber of the device while the screen keeps large contaminants out of device. A hose and hand pump or a hose and hose clamp are used to remove potable water, by pumping or using suction action generated by the mouth, from the bottom chamber of the device for use. Sea anchors on device keep the device from flipping over while floating in the water and the tether is used to secure the device to a raft or person(s).

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of water distillation and more specifically to a solar powered rescue and/or utility device for producing potable water from salt water, brine water or impure water.

Field of Search: 202/234,235, 203/10,dig1, 159/903,904, 441/80, 114/345,348

### REFERENCES CITED

U.S. Patent Documents

| | | |
|---|---|---|
| Patent 3501381 | DELANO WILLIAM RP | MAR 17, 1970 |
| Patent 3415719 | TELKES, MARIA | DEC 10, 1961 |
| Patent 3408260 | FELDMAN, HARRY W et al. | OCT 29, 1968 |
| Patent 3397117 | SMITH ROBERT et al. | AUG 13, 1968 |
| Patent 3351538 | ANDRASSY, STELLA | JUN 18, 1963 |
| Patent 2820744 | LIGHTER, STEPHEN | JUN 21, 1958 |
| Patent 2455835 | USHAKOFF, ALEXIS E | DEC 7, 1948 |
| Patent 2445350 | GINNINGS, DEFOE C | JUL 20, 1948 |
| Patent 2413101 | DELANO, WILLIAM R P | DEC 24, 1946 |
| Patent 2412466 | MILLER, JR WILLIAM | DEC 10, 1946 |

### BRIEF SUMMARY OF THE INVENTION

The primary object of the invention is a portable solar powered water distillation device for rescue and/or utility use that can be vacuum packed into a relatively small package.

Another object of the invention is that it can be used to desalinate salt water to generate potable water where salt water is present.

Another object of the invention is that it can be used to desalinate brine water to generate potable water where brine water is present.

A further object of the invention is that it can be used to generate potable water from dirty parasite filled water where dirty parasite filled water is available.

Yet another object of the invention is that it can be used by person(s) in a life raft to generate potable water from salt water to have potable water prior to rescue.

Still yet another object of the invention is that it can be used by down aviators, on land or sea, to generate potable water where unclean or salt water is present to have potable water prior to rescue.

Another object of the invention is that it can be used by special operations groups to generate potable water when needed while re-supply is unavailable and concealment is required.

Another object of the invention is it can be sized according to need or desired amount of potable water needed to be produced.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed a solar powered rescue and/or utility device for producing potable water from salt water, brine water or impure water comprising: an inflatable perimeter chamber (shape of perimeter chamber can vary i.e. Rectangular, Oval) made from a heavy weave of rip stop urethane coated material, or like material, to give device structural stability using the inflation tube or by an automatic inflation type canister, an upper skin, usually dark in color, made from a heavy weave of rip stop urethane coated material, or like material, covering the top of device which is held in place by a perimeter cuff, usually dark in color, made from a heavy weave of rip stop urethane coated material, or like material, utilizing Velcro type strips to hold upper skin in place, a lower skin, usually light in color, made from a heavy weave of rip stop urethane coated material, or like material, covering bottom of device which is held in place by a perimeter cuff, usually light in color, made from a heavy weave of rip stop urethane coated material, or like material, utilizing Velcro type strips to hold lower skin in place, a mid-level skin made from a medium weave of rip stop urethane coated material, or like material, which separates upper chamber and lower chamber of device, the mid-level skin having 8-10 slotted holes around top circumference of mid-level skin, the 8-10 slotted holes around top circumference in mid-level skin are covered and sealed with vapor porous hydrophobic membrane such as filter material used in laboratories of hospitals that allow filtering vapor from water, movable flap, usually dark in color, made from a heavy weave of rip stop urethane coated material, or like material, that covers hole incorporating a screen covering the hole in top skin and flap retainer cuff, usually dark in color, made from a heavy weave of rip stop urethane coated material, or like material, attached to top skin of the device, the hole with incorporated screen covering hole in top skin to allow salt or dirty water to be poured into the upper chamber of device while the incorporated screen over the hole in the top skin is to keep larger contaminants out of device, a clear plastic viewing port is utilized to monitor level of supply water in upper chamber, a hose made from clear soft plastic, or like material, similar to the tubes used in hospitals for IVs is attached to the lower skin by an attaching port or nipple and a hand pump are used to pump potable water from the lower chamber of the device what also can be used is a hose made from clear soft plastic, or like material, similar to the tubes used in hospitals for IVs is attached to the lower skin by an attaching port or nipple and a hose clamp is used to draw off potable water from lower chamber of the device by a suction action supplied by a persons mouth, the aforementioned hose clamp is used to keep the generated potable water in the lower chamber from leaking out, a strap is used to tie hose and pump, or hose and hose clamp, up along side of device while device is floating to keep hose and pump or hose and hose clamp available for use, sea anchors around bottom circumference of device to keep device from flipping over while floating in water, and tether or rope, which is attached to the device by an attaching lug, is used to tie the device to a raft or person(s).

In accordance with a preferred embodiment of the invention, there is disclosed a process using the solar powered rescue and/or utility device for producing potable water from salt water, brine water or impure water comprising the steps of:

inflate perimeter chamber to give device structural stability, slide flap from under the flap retaining cuff attached to top skin of the device to expose hole with incorporated screen covering it, pour water (Salt, Brine or impure) into the upper chamber of device (screen incorporated to keep larger contaminants out of device), replace flap back into original position so flap is covered by flap retaining cuff and the flap is laying flat, place device on ground or surface of water in direct sun light and let process, water level is to be monitored via clear plastic window in top skin of the device, Water level in upper chamber should maintained by adding slight amounts of water as level drops, vapor will be generated by heat from the sun, vapor will then pass thru hydrophobic vapor porous membrane into lower chamber of device where it will condense on lower skin due to heat sink effect, hose and hand pump or hose and hose clamp are used to pump or suction out potable water from lower chamber of the device.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a perspective view of the device.

FIG. 2 is a cross sectional view of the device.

### DETAILED DESCRIPTION OF THE PREFERRED EMBODIMENTS

Detailed descriptions of the preferred embodiment is provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

This invention relates generally to the field of water distillation and more specifically to a solar powered rescue and/or utility device for producing potable water from salt water, brine water or impure water and the process for making said water in situations where potable water is not readily available.

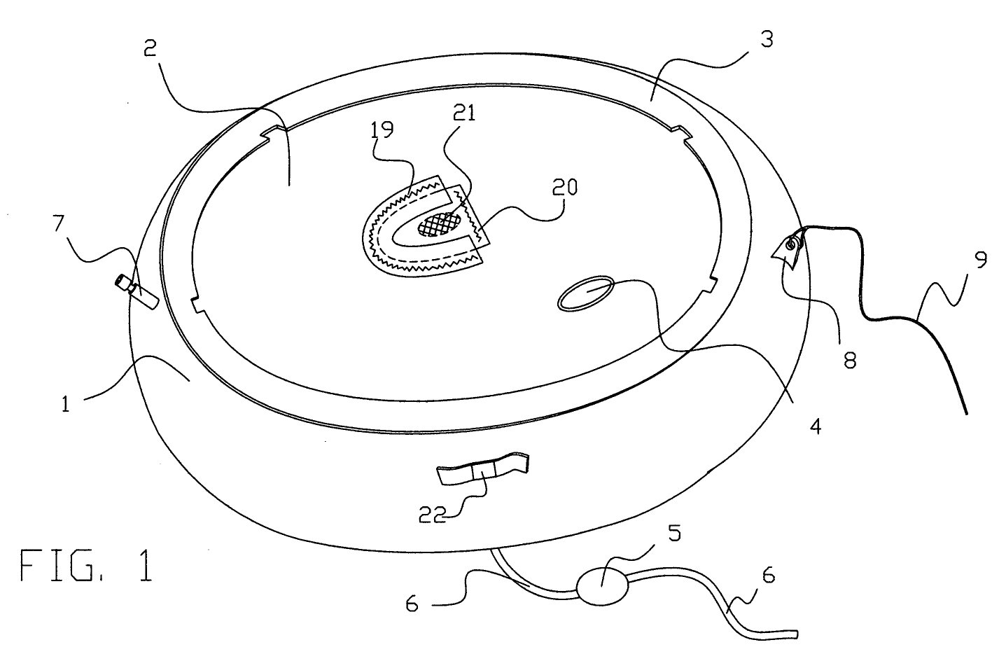

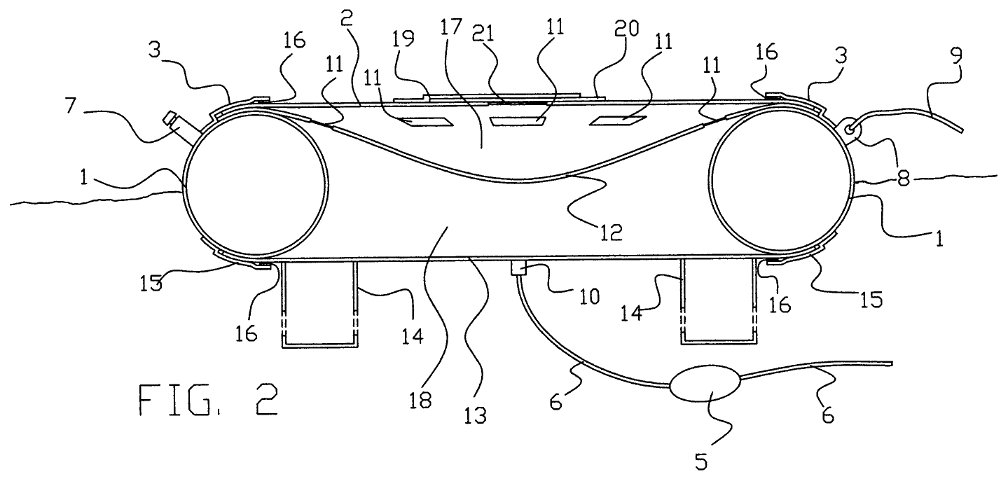

FIG. 1 perspective of the device shows and FIG. 2 cross section of the device shows a solar powered rescue and/or utility device for producing potable water from salt water, brine water or impure water comprising of an inflatable perimeter chamber made from a heavy weave of rip stop urethane coated material, or like material (FIG. 1&2, 1), (Perimeter shape can vary i.e. rectangular, oval etc.), to give device structural stability by using the inflation tube (FIGS. 1&2, 7) or inflating by using an automatic inflation type canister not shown. The device has a upper skin made from a heavy weave of rip stop urethane coated material, or like material (FIGS. 1&2, 2) covering top of the device which is held in place by a perimeter cuff made from a heavy weave of rip stop urethane coated material, or like material (FIGS. 1&2, 3) utilizing Velcro type strips (FIG. 2 16), under perimeter cuff, to hold the upper skin in place. The device has a lower skin made from a heavy weave of rip stop urethane coated material, or like material (FIG. 2, 13) covering bottom of the device which is held in place by a perimeter cuff made from a heavy weave of rip stop urethane coated material, or like material (FIG. 2, 15) utilizing Velcro type strips (FIG. 2, 16), under perimeter cuff, to hold the lower skin in place. The device also has a mid-level skin made from a medium weave of rip stop urethane coated material, or like material (FIG. 2, 12) which separates upper chamber (FIG. 2, 17) and lower chambers (FIG. 2, 18) of the device. The mid-level skin (FIG. 2, 12) having 8-10 slotted holes (FIG. 2, 11) around top circumference of the mid-level skin where these 8-10 slotted holes are covered with a vapor porous hydrophobic membrane much like filter material used in laboratories of hospitals which allows filtering vapor from water (FIG. 2, 11) that allows water vapor to pass through the membrane but does not allow water to pass. The device has a movable flap made from a heavy weave of rip stop urethane coated material, or like material (FIGS. 1&2, 20) attached to the top skin of the device that covers a hole which incorporates a screen (FIGS. 1&2, 21). The flap is held in place over the hole by a retainer cuff made from a heavy weave of rip stop urethane coated material, or like material (FIGS. 1&2, 19) attached to the top skin. The hole which incorporates a screen (FIGS. 1&2, 21) covering the hole in the top skin is to allow salt or dirty water to be poured into the upper chamber (FIG. 2, 17) of device while the screen that is incorporated over hole (FIGS. 1&2, 21) is to keep larger contaminants out of the device. A clear plastic viewing port (FIG. 1, 4) incorporated in the upper skin of the device is used to monitor the level of supply water in the upper chamber (FIG. 2, 17) of the device. A hose (FIGS. 1&2, 6) made from clear soft plastic, or like material, similar to the tubes used in hospitals for IVs, which is attached to the lower skin (FIG. 2, 13) by an attaching port or nipple (FIG. 2, 10), and a hand pump (FIGS. 1&2, 5) is used to pump potable water from the lower chamber (FIG. 2, 18) of device. A hose and hose clamp, not shown, made from clear soft plastic, or like material, similar to the tubes used in hospitals for IVs, can be attached to the lower skin by an attaching port or nipple (FIG. 2, 10) and can be used to remove the potable water from the lower chamber by a suction action supplied by the mouth. The hose clamp is used so as to not allow potable water in the device to leak out through the hose. A strap (FIG. 1, 22) attached to the side of the device is used to tie the hose and hand pump or hose and hose clamp (FIGS. 1&2, 6&5) up along side of device while the device is floating to keep hose and pump or hose and hose clamp available for use. Sea anchors (FIG. 2, 14) around the bottom circumference of device are utilized to keep the device from flipping over while floating in water and tether or rope (FIGS. 1&2, 9), which is attached to the device by a lug (FIG. 1, 8) can be used to attach the device to a raft or person(s).

In accordance with a preferred embodiment of the invention, there is disclosed a process using the solar powered rescue and/or utility device for producing potable water from salt water, brine water or impure water comprising the steps of: inflate perimeter chamber (1) (Perimeter shape can vary i.e. rectangular, oval) to give the device structural stability, slide the flap (20) from under the flap retaining cuff (19) to expose the hole which incorporates a screen covering it (21), pour water (Salt, Brine or impure) into the upper chamber (17) of device (the screen is incorporated in the hole to keep larger contaminants out of device), replace the flap (20) back into original position so the flap is covered by the flap retaining cuff (19) and the flap is laying flat, place the device on the surface of water or on the ground in direct sun light and let process, water level in upper chamber is to be monitored by clear plastic window (4) in top skin, the level of water should be maintain by adding slight amounts of water when required, water vapor will be generated by the heat from the sun, the water vapor will pass thru the Slots (11) in mid-level skin (12), that are covered with a hydrophobic vapor porous membrane, into the lower chamber (18) of device where it will condense on lower skin (13) due to heat sink effect of the sea water or the ground, the hose (6) and hand pump (5) or hose and hose clamp, not shown, are used to remove the potable water from the lower chamber (18) of the device either by pumping or utilizing a suction action generated by the mouth.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. A solar powered rescue and/or utility device for producing potable water from salt water, brine water or impure water that can be vacuum packed to a relative size. comprising:
1. an inflatable perimeter chamber made from a heavy weave of rip stop urethane coated material, or like material, (perimeter shape can vary i.e. rectangular, oval) to give device structural stability;
2. the device in claim 1 comprises of a upper skin made from a heavy weave of rip stop urethane coated material, or like material, covering top of the device and held in place by a perimeter cuff utilizing Velcro or like material so not to allow skin to move;
3. the device in claim 1 comprises of a lower skin made from a heavy weave of rip stop urethane coated material, or like material, covering bottom of the device and held in place by a perimeter cuff utilizing Velcro or like material so not to allow skin to move;
4. the device in claim 1 comprises of a mid-level skin made from a medium weave of rip stop urethane coated material, or like material, which separates upper and lower chambers of the device;
5. the device in claim 4 comprises of mid-level skin made from a medium weave of rip stop urethane coated material, or like material, having 8-10 slotted holes around top circumference of the mid-level skin;
6. the device in claim 4 comprises of 8-10 slotted holes, in mid-level skin, covered and sealed with vapor porous hydrophobic membrane such as filter material used in laboratories of hospitals that allow filtering vapor from water. This material allows vapor to pass through it but does not allow water to pass through it;
7. the device in claim 2 comprises of a movable flap made from a heavy weave of rip stop urethane coated material, or like material, that covers hole which incorporates a screen;
8. the device in claim 2 comprises of a flap retaining cuff made from a heavy weave of rip stop urethane coated material, or like material, attached to the top skin;
9. the device in claim 2 comprises of a hole which incorporates a screen covering the hole in top skin to allow salt or dirty water to be poured into the upper chamber of device while the incorporated screen keeps larger contaminates from entering the device, and;
10. the device in claim 3 comprises of a hose and hand pump, shown, or a hose and hose clamp, not shown, attached to lower skin to pump or suction out potable water from lower chamber of the device via an attaching port or nipple.

2. A process using the solar powered rescue and/or utility device for producing potable water from salt water, brine water or impure water comprising the steps of:
1. inflate perimeter chamber to give device structural stability;
2. slide flap from under the flap retaining cuff to expose hole with screen incorporated in it;
3. pour water (Salt, Brine or impure) into the upper chamber of device;
screen incorporated is used to keep larger contaminants out of device;
4. replace flap back into original position so flap is covered by flap retaining cuff and is laying flat;
5. place device on ground or on surface of water in direct sun light and let process;
6. water level in upper chamber is to be monitored by clear plastic window. Water should be maintained by adding slight amount of water to maintain level;
7. Water vapor will be generated by heat from sun;
8. The water vapor will pass thru hydrophobic vapor porous membrane into lower chamber where it will condense on lower skin due to heat sink effect of sea water or the ground.
9. The potable water will then be pumped out from the lower section or suctioned out of the lower chamber for use.
